(19) United States
(12) Patent Application Publication
(10) Pub. No.: US 2004/0189792 A1
(43) Pub. Date: Sep. 30, 2004

(54) Security system using mobile phone

(75) Inventors: Souk-Joung Joon, Suji-eup Yongin-shi (KR); Young-Ro Kim, Seoul (KR)

Correspondence Address: Frank Chau, F. CHAU & ASSOCIATES, LLP, Suite 501, 1900 Hempstead Turnpike, East Meadow, NY, 11554, US

(73) Assignee: Samsung Electronics Co., Ltd.

(21) Appl. No.: 10/797,848

(22) Filed: Mar. 10, 2004

(30) Foreign Application Priority Data
Mar. 28, 2003 (KR) 2003-19654

(51) Int. Cl. H04N 7/14; G08B 13/00

(52) U.S. Cl. 348/14.02

(57) ABSTRACT

A security system is provided that uses a video processor of a video mobile phone to detect a moving object, and includes a video mobile phone for capturing external images and determining changes from the external images, transmitting alarm signals and compressing to transmit alarm video frames; an alarm generator for receiving alarm control signals from the video mobile phone to alarm; and an alarm video storage device for receiving and storing the alarm video frames transmitted from the video mobile phone.

### FIELD OF THE INVENTION

The present invention relates to security systems using video mobile phones, and more particularly to a security system using a video processor of the video mobile phone to detect motion.

### BACKGROUND OF THE INVENTION

As crime rates continue to increase, so too does the need for improved security systems. Some security systems utilize an extra camera that has a charge-coupled device (“CCD”) for sensing motions and sounds. With the camera, the security systems detect a moving object and sound to determine whether either is beyond a threshold value. If a motion or sound is beyond a threshold value, the security system alarms to notify a user and/or stores the video frames relevant to the alarm.

Employing such security systems requires relatively expensive apparatus and installation work. Therefore, the security systems may not be practically used in general home and office applications despite their functionality.

### SUMMARY

These and other drawbacks and disadvantages of the prior art are addressed by an apparatus and method for providing security with a video mobile phone. A security system with a video mobile phone includes motion detection.

Embodiments of the present invention provide a security system for sensing an external moving object using a video processor mounted in a video mobile phone, and transmitting an alarm signal and alarm-related video frames.

According to an aspect of the invention, a security system using a mobile phone includes a video mobile phone having a security function for capturing external images and determining changes from the captured external images to transmit alarm control signals and video frames, an alarm generator for receiving the alarm control signals from the video mobile phone to generate an alarm, and an alarm video storage device for receiving and storing the alarm video frames transmitted from the video mobile phone.

### BRIEF DESCRIPTION OF THE DRAWINGS

The present invention may be better understood in accordance with the following exemplary figures, in which:

FIG. 1 is a schematic diagram showing a security system using a video mobile phone in accordance with principles of the present invention;

FIG. 2 is a flowchart showing the operations of the security system of FIG. 1;

FIG. 3 is a block diagram showing an embodiment of the security system of FIG. 1;

FIG. 4A is a block diagram showing a first embodiment of the video processor illustrated in FIG. 3;

FIG. 4B is a block diagram showing a second embodiment of the video processor illustrated in FIG. 3; and FIG. 5 is a block diagram showing a decoder circuit of the video processor employed in restoring a DC coefficient and a motion vector for generating compressed video frames in the second embodiment illustrated in FIG. 4B.

### DETAILED DESCRIPTION OF PREFERRED EMBODIMENTS

A security system with mobile phone is provided for enabling motion detection. Embodiments of the present invention provide a security system for sensing an external moving object using a video processor mounted in a video mobile phone, and transmitting an alarm signal and alarm-related video frames.

In a preferred embodiment, a security system using a mobile phone includes a video mobile phone having a security function for capturing external images and determining changes from the captured external images to transmit alarm control signals and video frames, an alarm generator for receiving the alarm control signals from the video mobile phone to generate an alarm, and an alarm video storage device for receiving and storing the alarm video frames transmitted from the video mobile phone.

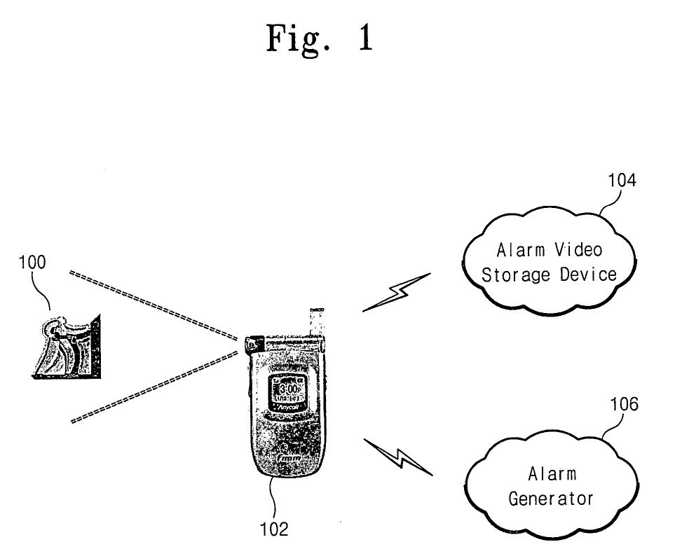

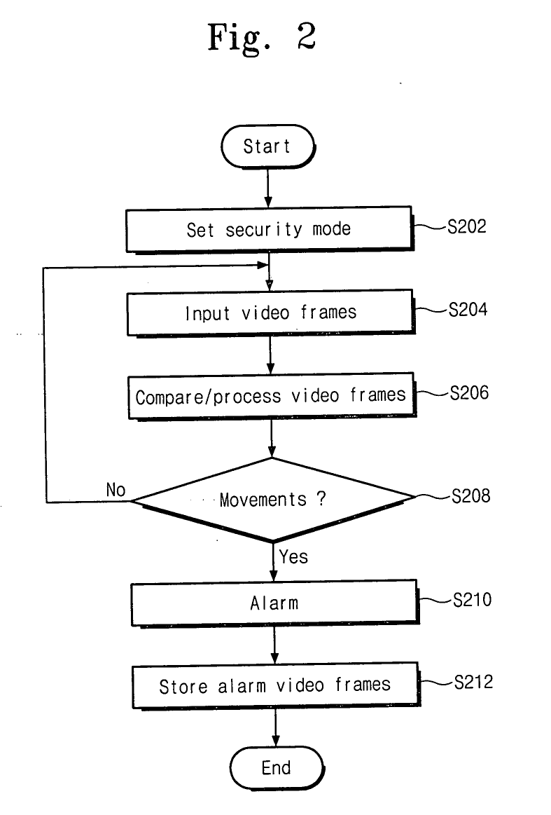

FIG. 1 is a schematic diagram showing a security system embodiment using a video mobile phone, and FIG. 2 is a flowchart showing the operations of the security system of FIG. 1.

As shown in FIG. 1, a security system using a video mobile includes a security threat 100, a video mobile phone 102 for observing the security threat, an alarm video storage device 104 in signal communication with the video mobile phone, and an alarm generator 106 in signal communication with the video mobile phone.

Turning to FIG. 2, the security system using a video mobile phone of FIG. 1 includes a function block S202 for setting a security mode, which passes control to a function block S204 for receiving input video frames. The block S204 passes control to a function block S206 for comparing and processing video frames, which, in turn, passes control to a decision block S208 that checks for movements.

If movements are not detected, control is passed back to the function block S204. However, if movements are detected, control is passed to a function block S210 that initiates an alarm. The function block S210, in turn, passes control to a function block S212 that stores alarm video frames.

Thus, the security system embodiment of FIGS. 1 and 2 disposes a video mobile phone 102 having a security function in the path of an expected invasion and sets a security mode (step S202). In the security mode, the video mobile phone 102 receives images captured by an included camera into the video mobile phone (step S204).

The video mobile phone 102 compares the video frames of the external images (step S204) to determine whether there is an invasion 100 (step S208). If there is an invasion 100, the video mobile phone 102 may notify a security service or police, or call to a predefined telephone number using radio communications, and also generates an alarm (step S210) with an alarm generator 106. At the same time, the video mobile phone 102 transmits the captured current external images wirelessly to alarm video storage devices such as a server of the security service, an adjacent computer, or camcorder, thereby preserving the evidence. If there is no invasion, the video mobile phone repeats the comparison operation until the security mode is canceled by a user.

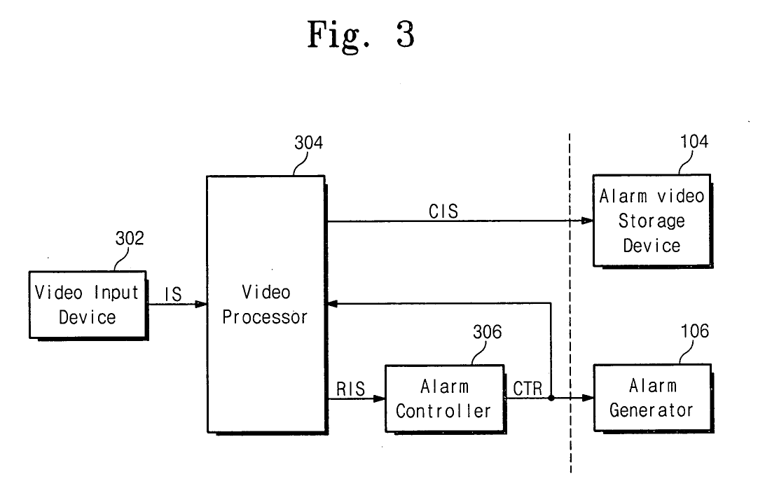

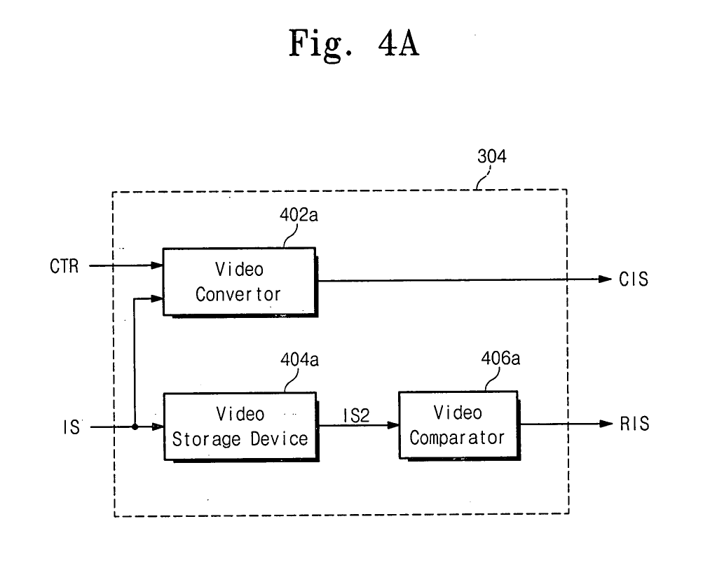

FIG. 3 is a detailed block diagram showing the video mobile phone of the present invention.

Turning now to FIG. 3, a security system embodiment using a video mobile phone includes a mobile phone having a video input device 302 and a video processor 304 in signal communication with the video input device. The video mobile phone further includes an alarm controller 306 in signal communication with the video processor. The alarm controller of the video mobile phone is in signal communication with an alarm generator 106, while the video processor is in signal communication with an alarm video storage device 104.

As described above, the video mobile phone of the FIG. 3 operates the security function using a video processor mounted in the existing video mobile phone, which includes a video input device 302, a video processor 304 and an alarm controller 306. The video input device 302 utilizes an installed camera to capture the external images and inputs video frames IS of the captured external images into the video mobile phone 102 of FIG. 1. The video processor 304 compares the video frames IS inputted from the video input device 302 to generate the result values RIC with respect to the difference between the frames, and converts the video frames IS according to input control signals. The alarm controller 306 controls the alarm according to the result values RIC generated by the video processor 304.

When the security mode is set in the video mobile phone 102 employed in the security system of FIGS. 1 or 3, the video input device 302 of the video mobile phone 102 of FIG. 1 captures the external images with the installed camera and then continuously inputs the captured video frames IS into the video mobile phone 102.

The video processor 304 compares the video frames continuously inputted from the video input device 302 to determine whether there is a moving object, and generates the result values RIS. In addition, the video processor 304 compresses and transmits the video frames IS according to the control signals CTR from the alarm controller 310 to an alarm video storage device 104.

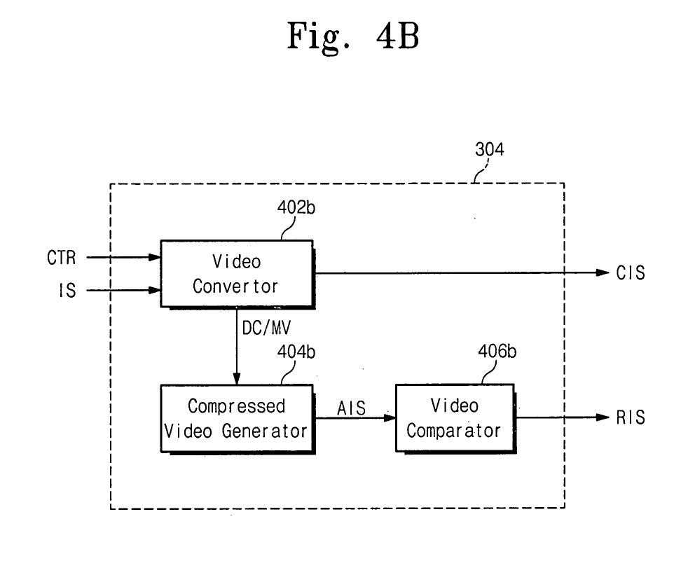

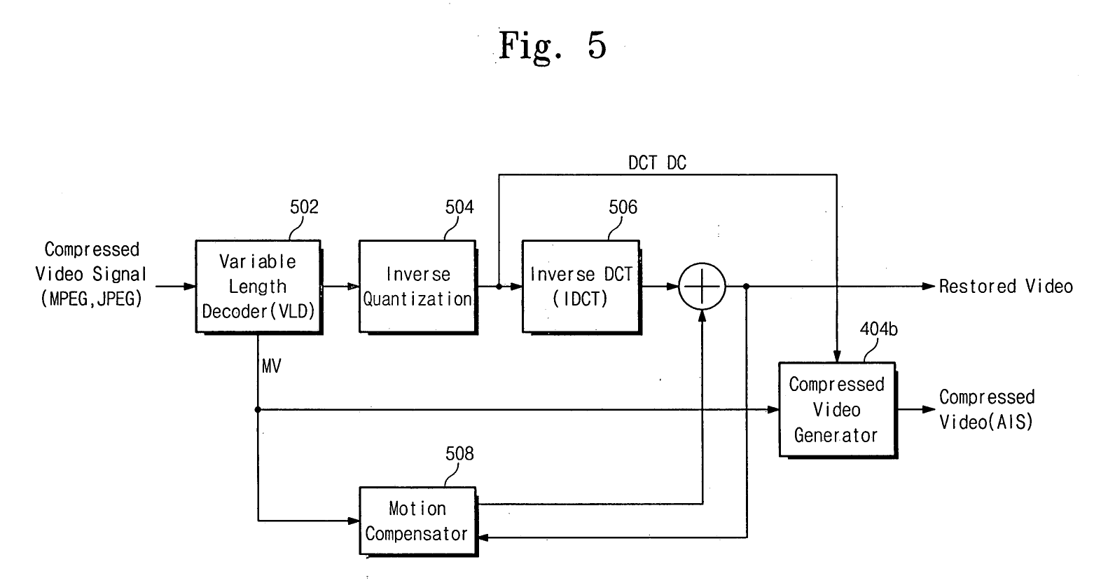

FIGS. 4A and 4B are block diagrams showing embodiments of a video processor 304 according to the present invention.

As shown in FIG. 4A, a first embodiment video processor 304 includes a video converter 402a for receiving first and second input signals and providing a first output signal. The video processor 304 further includes a video storage device 404a for receiving the second input signal. The video storage device 404a is in signal communication with a video comparator 406a, for providing a second output signal.

Thus, the video processor embodiment 304 of FIG. 4A includes a video storage device 404a, a video comparator 406a and a video converter 402a. The video storage device 404a stores the original video frames IS inputted from the video input device 302 or the sampled original video frames. The video comparator 406a compares the video frames IS2 stored in the video storage device 404a to generate the result values RIS of comparing. The video converter 402a generates the compressed video signals CIS of the original video frames IS according to the control signals CTR.

FIG. 4B is another embodiment of the video processor 304 for generating the result values of a comparison using the compressed video frames AIS generated from the compressed video signal CIS.

Turning to FIG. 4B, a second embodiment video processor 304 includes a video converter 402b for receiving first and second input signals and providing a first output signal. The video converter is in signal communication with a compressed video generator 404b. The compressed video generator 404b, in turn, is in signal communication with a video comparator 406b, for providing a second output signal.

Thus, the second embodiment video processor 304 of FIG. 4B includes a video converter 402b, a compressed video generator 404b and a video comparator 406b. The video converter 402b compresses the original video frames IS to generates compressed video signals CIS and generates the compressed video signal CIS according to control signals CTR. The compressed video generator 404b generates compressed video frames AIS using a DC coefficient of compressed video signal CIS generated during decoding in the video converter 402b and motion vector MV. The video comparator 406b compares the compressed video frames AIS to generate result values RIS of comparing.

FIG. 5 is a block diagram showing a decoder circuit of the video processor 304 employed in restoring DC coefficient and motion vector for generating compressed video frames AIS in the embodiment illustrated in FIG. 4B.

Turning now to FIG. 5, a decoder circuit of the video processor 304 of FIG. 4B includes a variable length decoder 502 for receiving a first input. The variable length decoder is in signal communication with an inverse quantization unit 504, which, in turn, is in signal communication with an inverse DCT unit 506 that provides a first non-inverted input to a summing unit.

The variable length decoder 502 is in further signal communication with a first input of a compressed video generator 404b. A second input of the compressed video generator 404b is in signal communication with the inverse quantization unit 504, the compressed video generator 404b for providing a compressed video output.

The variable length decoder 502 is additionally in signal communication with a first input of a motion compensator 508, the output of which is in signal communication with a second non-inverting input of the summing unit. The output of the summing unit is for providing restored video, and is in signal communication with a second input of the motion compensator 508.

Thus, the compressed video signal CIS is restored to the original video frames by the decoder circuit illustrated in FIG. 5, the compressed video signal CIS being compressed, for example, in accordance with motion picture expert group (“MPEG”) or joint picture expert group (“JPEG”) standards by the video converter 402b of the video processor 304.

That is, when the compressed video signals CIS are input, a variable length decoder 502, an inverse quantizer 504 and an inverse discrete cosine converter 506 of the decoder circuit apply intraframe compression to each frame of the original video frames. A motion compensator 508 using a motion vector MV, generated by the variable length decoder 502, applies interframe compression to the continued original video frames. Thus, the original video frames are restored.

In the above restoring process, the compressed video generator 404b generates compressed video frames AIS using the DC coefficient restored by the inverse quantizer 504 and the motion vector MV generated by the variable length decoder 502.

The video comparator 406a or 406b of FIGS. 4A or 4B, respectively, compares the correlation between input video frames IS2 or AIS with a threshold value defined by a user to determine whether there is a moving object. In this case, the correlation between the video frames can be obtained by a summation of absolute values of differences between the pixel luminance Yₜ(i, j) of current video frames and the pixel luminance Yₜ₋ᵣ(i, j) of arbitrary previous video frames, as described in the following formula:

$${\sum }_{i = 0}^{N} {\sum }_{j = 0}^{M} \vert {Y}_{t} ( i , j ) - {Y}_{i - r} ( i , j ) \vert , \qquad ( 1 )$$

where N and M are sizes of vertical or parallel axes of a video frame, and (i, j) are the coordinate values of a pixel.

If there is no change in the input video frames, the correlation between the two video frames used in the formula 1 increases to make the value of the formula 1 approximate “0”. However, if there is a moving object, the correlation between the two video frames decreases, such that the value of the formula 1 drastically increases. The current video frame Yₜ(i, j) may be compared with the adjacent previous video frame Yₜ₋₁(i, j). However, when there is only a slight motion, the value of formula 1 may increases linearly and decreases within the limitation of threshold value defined by a user. As a result, the invasion may not be detected. Thus, as referred to the formula 1, even slight motion may be detected by comparing the current frame with an alternative one (e.g., Yₜ₋ᵣ(i, j)) of the previous frames.

The video comparator 406a or 406b compares the video frames to each other in the above manner and generates the result values RIS of comparing to an alarm controller 306. The alarm controller 306 generates control signals CTR according to the input result values RIS. If a moving object is detected as a result of the comparison, the alarm controller 306 inputs control signals CTR for alarming to the alarm generator 106 and the video processor 304. According to the control signal CTR, the alarm generator 106 alarms and the video processor 304 compresses the input external images to transmit to the external alarm video storage device 104. The transmitted video is stored in the alarm storage device 104 to be used as evidence.

Thus, embodiments of the present invention provide an effective security system without additional installation work and with low cost. These and other features and advantages of the present invention may be readily ascertained by one of ordinary skill in the pertinent art based on the teachings herein. It is to be understood that the principles of the present invention may be implemented in various forms of hardware, software, firmware, special purpose processors, or combinations thereof.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A security system comprising:
a video mobile phone having a security function for capturing external images, determining changes from previous external images, and transmitting alarm control signals and alarm video frames responsive to the determined changes;
an alarm generator in signal communication with the video mobile phone for receiving the alarm control signals from the video mobile phone and generating an alarm; and
an alarm video storage device in signal communication with the video mobile phone for receiving and storing the alarm video frames transmitted from the video mobile phone.

2. The security system of claim 1, wherein the video mobile phone comprises:
a video input device for capturing and inputting external images into the video mobile phone;
a video processor for comparing video frames inputted from the video input device to generate result values and compressing the alarm video frames according to control signals; and
an alarm controller for generating control signals to control the alarm according to the result values generated by the video processor.

3. The security system of claim 2, wherein the video processor comprises:
a video storage device for storing at least one of captured video frames inputted from the video input device and sampled video frames;
a video comparator for comparing the video frames stored in the video storage device to generate result values; and
a video converter for compressing and transmitting the video frames according to control signals from the alarm generator.

4. The security system of claim 3, wherein the video comparator compares the sum of absolute values of differences between the pixel luminance of a current video frame and the pixel luminance of a stored arbitrary video frame with a threshold value defined by an user, thereby generating result values.

5. The security system of claim 2, wherein the video processor comprises:
a video converter for converting the inputted video to generate alarm video according to control signals from an alarm controller and decoding the converted video frames;
a compressed video generator for generating compressed video with video signals generated during decoding by the video converter; and
a video comparator for comparing the compressed video to generate the result values.

6. The security system of claim 5, wherein the compressed video is produced with a DC coefficient selected from the decoding and a motion vector.

7. The security system of claim 5, wherein the video comparator compares the sum of absolute values of differences between the pixel luminance of a current video frame and the pixel luminance of a stored arbitrary video frame with a threshold value defined by an user, thereby generating result values.

8. A method of securing using a video mobile phone having a securing function, comprising the steps of:
a) setting a security mode and a threshold value with the securing function as a basis for determining whether there is motion relative to the video mobile phone;
b) inputting external images captured with a camera of the video mobile phone into the video mobile phone in the set security mode;
c) processing video frames for at least one of compressing and storing the inputted video frames and comparing the video frames to generate result values;
d) signaling an alarm according to a result of comparing the video frame; and
f) transmitting the alarm video frames inputted to the video mobile phone to a storage device.

9. The method of claim 8, wherein step c) compares the sum of absolute values of differences between the pixel luminance of a current video frame and the pixel luminance of a stored arbitrary video frame with a threshold value defined by a user, thereby generating result values.

10. The method of claim 9, wherein the video frames are originally captured images.

11. The method of claim 9, wherein the video frames are image frames obtained by sampling originally captured images.

12. The method of claim 9, wherein the video frames are image frames compressed from originally captured images.

13. A security system comprising:
a video mobile phone;
an alarm video storage device in signal communication with the video mobile phone; and
an alarm generator in signal communication with the video mobile phone.

14. A security system as defined in claim 13, further comprising a program storage device defining program steps for:
setting a security mode;
receiving video frames responsive to the set security mode;
at least one of comparing and processing the received video frames;
detecting movements responsive to the received video frames;
signaling an alarm responsive to the detected movements; and
storing received video frames relevant to the signaled alarm.

15. A security system as defined in claim 13, the video mobile phone comprising:
a video input device;
a video processor in signal communication with the video input device; and
an alarm controller in signal communication between the video processor and the alarm generator.

16. A security system as defined in claim 15, the video processor comprising:
first and second input terminals;
a video converter in signal communication with the first and second input terminals;
a video storage device in signal communication with at least one of the first and second input terminals; and
a video comparator in signal communication with the video storage device.

17. A security system as defined in claim 16, the video converter comprising:
a variable length decoder;
a motion compensator in signal communication with the variable length decoder;
an inverse quantization unit in signal communication with the variable length decoder;
an inverse discrete cosine transformer in signal communication with the inverse quantization unit; and
a summing unit in signal communication with the inverse discrete cosine transformer and the motion compensator.

18. A security system as defined in claim 15, the video processor comprising:
a video converter;
a compressed video generator in signal communication with the video converter; and
a video comparator in signal communication with the compressed video generator.

19. A security system as defined in claim 18, the video converter comprising:
a variable length decoder;
a motion compensator in signal communication with the variable length decoder;
an inverse quantization unit in signal communication with the variable length decoder;
an inverse discrete cosine transformer in signal communication with the inverse quantization unit; and
a summing unit in signal communication with the inverse discrete cosine transformer and the motion compensator.

20. A security system as defined in claim 19 wherein the compressed video generator is in signal communication with the variable length decoder and the inverse quantization unit.
